(19) United States
(12) Patent Application Publication
(10) Pub. No.: US 2010/0066532 A1
(43) Pub. Date: Mar. 18, 2010

(54) METHOD AND APPARATUS FOR GATHERING DATA AND POWER SUPPLY FOR A RADIO TRANSCEIVER

(76) Inventor: Duncan Bremner, Johnshill (GB)

Correspondence Address: VINSON & ELKINS L.L.P., First City Tower, 1001 Fannin Street, Suite 2300, HOUSTON, TX, 77002-6760, US

(21) Appl. No.: 12/310,173

(22) PCT Filed: Aug. 3, 2007
(86) PCT No.: PCT/GB2007/002940

§ 371 Date: Oct. 30, 2009

(30) Foreign Application Priority Data
Aug. 15, 2006 (GB) 0616224.2

(51) Int. Cl. G08B 1/08

(52) U.S. Cl. 340/539.16

(57) ABSTRACT

A system for gathering data from at least one mobile station (107) at a central station (100), the system comprises a plurality of remote nodes (105) or radio transceiver. Each node (105) receives wirelessly, data from at least one mobile station (107); and a wire (electric) fence (103) connected to each of the plurality of nodes (105) and said central station (105) transfers the received data from each of the plurality of remote nodes (105) to the central station (100). Each node (105) is powered by the electric fence (103).

### FIELD OF THE INVENTION

The present invention relates to a method and apparatus for gathering data and a power supply for a radio transceiver. In particular, it relates to use of wire fences to transfer data from a mobile station to a central station and to supply power to a radio transceiver

### BACKGROUND OF THE INVENTION

In large scale monitoring systems there exists a plurality of electronic devices which generate monitoring data at remote locations recording various conditions within the environment of the monitoring system. It is desirable to collate this data at a central location for analysis etc. In existing systems this data is downloaded and transmitted via a dedicated network. Installing and maintaining such a network is time consuming and expensive.

Such monitoring systems are becoming increasingly popular in the farming industry. The ability to monitor animal health is becoming more important. This monitoring is usually done using an animal borne sensor/recorder device such that the data may be gathered over a period of time, stored locally, and interrogated wirelessly when the animal approaches a known location; say a feeding or milking station. However, in herd animals such as beef cattle, it can be difficult to position an interrogation device close to where the animals spend the majority of their time such as remote pastures. Furthermore, complex networks are required to transmit the downloaded data to a central computer for analysis and display to the stockman.

### SUMMARY OF THE INVENTION

The invention aims to overcome the need for a dedicated, complex network to support a monitoring system by utilising existing facilities at the site, such as a wire fence.

This is achieved according to a first aspect of the present invention by a method of gathering data from a plurality of mobile stations at a central station, the method comprising the steps of transmitting data wirelessly from at least one of a plurality of mobile stations to at least one remote node; driving a line to transfer the received data from the at least one remote node to a central station, wherein the line comprises a wire fence.

This is also achieved according to a second aspect of the present invention by apparatus for gathering data from a plurality of mobile stations at a central station, the apparatus comprising a transceiver for receiving, wirelessly, data from a plurality of mobile stations; a driver for driving a line to transfer the received data to a central station, wherein the line comprises a wire fence.

This is also achieved according to a further aspect of the present invention by a system for gathering data from a plurality of mobile stations at a central station, the system comprising a central station; at least one remote node, the at least one remote node receiving, wirelessly, data from at least one of a plurality of mobile stations; and a wire fence connected to the at least one remote node and the central station for transferring the received data from the at least one remote node to the central station.

This is also achieved according to yet a further aspect of the present inventions by a radio transceiver device for wirelessly communicating with at least one sensory device, the radio transceiver having power supplied by a power supply of an electric fence.

Although reference is made here to a mobile station, the mobile station may be temporarily fixed at a remote location, for example in a preferred embodiment fixed to a post or wall of a building for monitoring environmental parameters such as temperature etc.

Furthermore, in the preferred embodiment the wire fence is an electric fence used to contain animals or humans in an enclosure and/or keep animals or humans out of an enclosure. The mobile stations may comprise animal borne sensory device. The remote nodes are easy to install and require no change in their positions to suit animal movements. In utilising the existing electric fence on the farm, an effective network is provided which comprises a plurality of radio transceivers located at a plurality of sites over the network of fencing. In this way installation and maintenance of the system requires minimal effort and expense.

Further, the use of the wire fence is well understood technology and its deployment is very familiar. Further, the power source for electric fences is either mains powered or significantly large battery to permit a small radio transceiver to be easily powered by the power source.

Wire fences require a long length of conductive tape/wire/cable strung across an area, such as farmland, for example which, invariably is close to the mobile stations. This conductive medium can easily be used to relay the information from the mobile stations, back to the central station such that data is gathered at the central station.

In this way a highly effective, inexpensive, existing medium, which is already highly maintained, can be utilised in an ever modernising and difficult environment such as farming. The apparatus of the invention is flexible and can be used in many different environments for communicating data without the need of installing a dedicated network.

### BRIEF DESCRIPTION OF THE DRAWINGS

For a more complete understanding of the present invention, reference is now made to the following description taken in conjunction with the accompanying drawings, in which:

FIG. 1 is a simplified schematic diagram of the system according to a preferred embodiment of the present invention;

FIG. 2 is a simplified diagram illustrating the method of transceiving the data packets according to the preferred embodiment of the present invention;

FIG. 3 is a simplified schematic diagram of the apparatus according to the preferred embodiment of the present invention; and

FIG. 4 is a simplified schematic diagram of the apparatus for driving the line according to the preferred embodiment of the present invention.

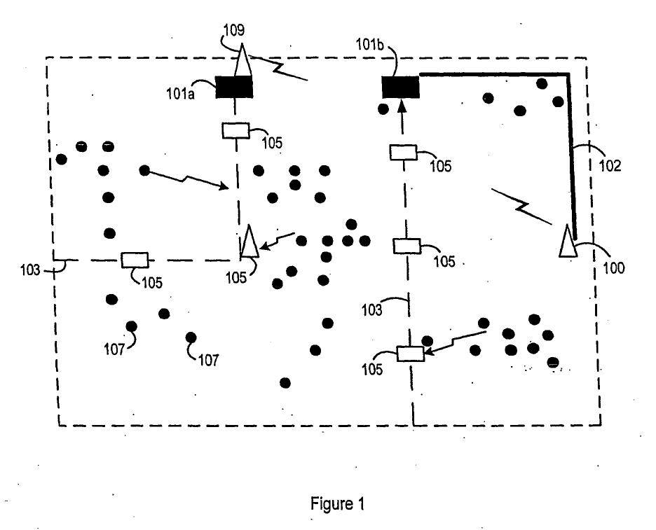

As illustrated in FIG. 1, the system according to an embodiment of the present invention comprises a central station 100. The central station 100, in the preferred embodiment, is a computer system or PC located in farm buildings or office or a network terminal device for forwarding data onto a processor at another location. The central station 100 includes a display and keyboard to enable the user to interrogate the system and obtain information relating to his livestock.

The central station 100 communicates with an energiser 101b, wirelessly or via a wired link 102. The energiser 101b energises a plurality of electric fences 103 located around the farm for containing the livestock in pre-designated areas or preventing livestock entering pre-designated areas. The electric fence 103 may comprise separate fence arrangements having associated energisers 101a and 101b. A remote energiser 101a comprises an antenna 109 for wireless communication to a second energiser 101b for communication to the central station 100. Of course the system can be implemented in a simpler system comprising a single energiser and fence arrangement. The fences 103 may be wire/cable or tape.

The fences 103 comprise a plurality of transceiver nodes 105 located at predefined intervals along the length of the electric fences 103. Each of the transceiver nodes 105 comprises an antenna for wirelessly communicating with a plurality of mobile stations 107. In the preferred embodiment, the mobile stations 107 comprise a network of sensory devices worn by the livestock for monitoring the condition, including health and habits, of the animals.

In the cases where the length of the electric fence is excessively long (miles), and the relay of data back to the power unit would be attenuated below a level that can be discriminated at the power source, it is possible to incorporate ‘transceiver nodes’ along the length of the cable such that the low level RF signals are boosted and forward at an increased amplitude. These ‘transceiver nodes’ which would be very similar to normal electric fence supports, extract power from the deterrent pulse and, based on an agreed time division multiplex protocol, relay the information back to the power node for onward transmission. These nodes are capable of either using the electric fence tape as a medium or use a separate wireless channel.

Although the preferred embodiment is being described with reference to a farm environment, it can be appreciated that the system could be implemented with respect to a security fence in which surveillance and security data are communicated to a central station. In a further alternative, the system may be implemented in monitoring crops; fruit trees or have military applications.

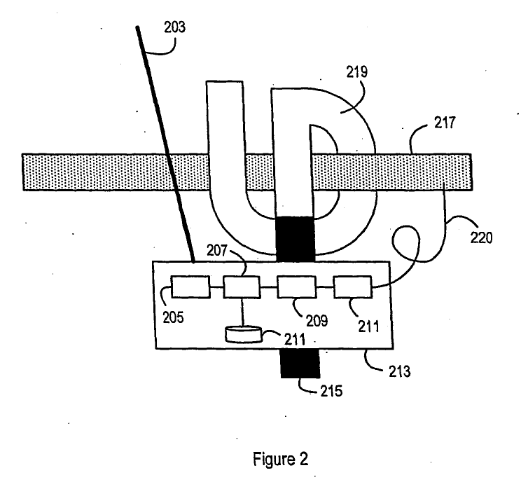

In a preferred embodiment, the system is implemented with a standard earth wire return electric fence. The transceiver node of a preferred embodiment will be described in more detail with reference to FIG. 2. The transceiver node 200 comprises an antenna 203 connected to a transceiver 205. The transceiver 205 is connected to a processor 207. The processor 207 is connected to a driver 209 and a local memory store 211. The transceiver node 200 also comprises a power supply controller 211 for controlling the power to the components of the transceiver node 200. The transceiver node comprises a sealed, weather-tight housing 213. The antenna 203 may form an integral unit with the housing 213 or may protrude from the housing 213 as shown. The housing 213 of the transceiver node 200 is securely mounted on a fence post 215 supporting a wire fence 217. The wire fence 217 is mounted through insulative support 219. The fence posts 215 are provided at predetermined interval to support the wire fence 217 at a predetermined height for deterring animals.

The transceiver node 200 further comprises a power tap 220 connected to the power supply controller 211 of the transceiver node 200. The power tap 220 may inductive or capacitive. The power tap 220 utilises the deterrent pulses to provide the power requirements for the components of the transceiver node.

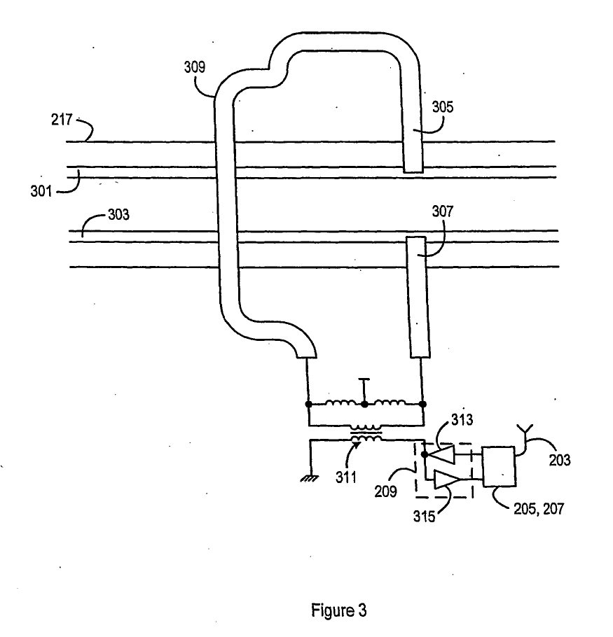

Connection of the driver 209 of the transceiver node 200 in accordance with a preferred embodiment is shown in FIG. 3. The wire fence 217 comprises a tape having a pair of conductors 301, 303. Each conductor 301, 303 is conductively connected to respective arms 305, 307 of a clip 309. The conductors 301, 303 are connected across transformer coils 311 via the clip 309. The transformer 311 is connected to a transmitter 313 and receiver 315 of the driver 209 of the transceiver node 200. The driver 209 is connected to the antenna 203 via the transceiver and processor units 205, 207.

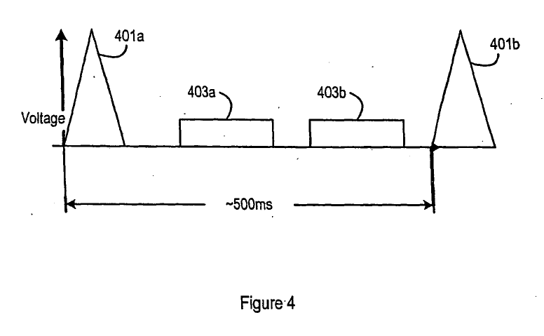

Operation of the transceiver node and the system of FIGS. 1 and 2 will now be described with reference to FIG. 4.

The plurality of mobile stations 107 collate and temporarily store data. In the case of animal borne sensory devices, the mobile stations 107 comprise a network of sensors, at least one of which is attached to the animal being monitored. The sensory data is then collated by a device worn by the animal, for example, attached to a neck collar. The data is temporarily stored on the device worn by the animal and transmitted, wirelessly, to a remote node, transceiver node 105, at regular time intervals or upon interrogation by the transceiver node 105 when the mobile station 107 (animal borne sensor device) is within the vicinity of the node.

The downloaded data is then buffered by the transceiver node 105 and is driven onto the electric fence 103 (which is in the proximity of the animals) to be transferred to the central station 100 for analysis etc. As the transceiver nodes 105 are located at intervals along the length of the fence 103, the node may also comprise means to boost the signals being transmitted to the central station. The data is transferred by the electric fence 103 between deterrent pulses which travel along the electric fence 103 to shock any animal in contact with fence 103. The deterrent pulses are generated by the energisers 101a and 101b. The deterrent pulses 401a and 401b may be transmitted at predetermined time intervals such as 500 ms and shown in FIG. 4. The data can be transferred in data packets 403a, 403b in between consequentive deterrent pulses 401a, 401b. To avoid interference between deterrent pulses and the data pulses, the transceiver node 200 may also include means to detect the occurrence of a deterrent pulse and if the period following the pulse is free, drive the line to upload the next packet to be transmitted to the central station. The data may be transmitted utilising time synchronisation, token ring or any other known techniques between deterrent pulses.

Although the system of the preferred embodiment has been described in some detail with respect to transmitting data from a mobile station to a central station, it can be appreciated that data and/or commands can be transmitted from the central station to an identified mobile station.

The system has been architected such that the user of transceiver nodes and normal animal sensor nodes can both utilise the same electric fence segment without interaction.

The power node pulses, the remote receiver interrogation, the intermediate transceiver nodes, and the back haul transmission, either via wireless or wired protocols are synchronised such that the interference between any of these events is minimised.

Therefore, the present invention permits rigid, low cost and effective deployment of interrogation utilising existing devices (electric fences) on the farm. This also increase the coverage and range of the monitoring system by incorporating transceiver nodes to receive and boost the signal being returned to the central station using the system described above with reference to FIGS. 1 to 4.

It allows the use of existing and well understood technology while extending the functionality of that technology and minimal marginal cost to provide a farm wide monitoring system. Furthermore, the locations of the existing electric fences are ideally located to gather and relay the data back to the central station in a highly cost effective manner. Finally, the inclusion of strategically placed transceiver nodes, which gather their power requirements from the electric fence pulse and are capable of relaying the data back along the length of the fence to the central station means the additional effort required to retrieve data from remote locations is dramatically reduced.

Although a preferred embodiment of the present invention has been illustrated in the accompanying drawings and described in the foregoing description, it will be understood that the invention is not limited to the embodiment disclosed but is capable of numerous modifications without departing from the scope of the invention as set out in the following claims.

1. A method of gathering data from a plurality of mobile stations at a central station, said method comprising the steps of:
transmitting data wirelessly from at least one of a plurality of mobile stations to at least one remote node;
driving a line to transfer said received data from said at least one remote node to a central station, wherein said line comprises a wire fence.

2. A method according to claim 1, wherein said wire fence comprises an electric fence.

3. A method according to claim 2, wherein said electric fence comprises an electric fence for deterring a subject.

4. A method according to claim 1, wherein at least one of said plurality of mobile stations comprises at least one animal borne sensory device.

5. A method according to claim 1, wherein said at least one remote node comprises a radio transceiver.

6. Apparatus for gathering data from a plurality of mobile stations at a central station, said apparatus comprising:
a transceiver for receiving, wirelessly, data from a plurality of mobile stations;
a driver for driving a line to transfer said received data to a central station, wherein said line comprises a wire fence.

7. Apparatus according to claim 6, wherein said wire fence comprises an electric fence.

8. Apparatus according to claim 7, wherein said electric fence comprises an electric fence for deterring a subject.

9. Apparatus according to claim 6, wherein at least one of said plurality of mobile stations comprises at least one animal borne sensory device.

10. Apparatus according to claim 6, further comprising a repeater unit.

11. A system for gathering data from a plurality of mobile stations at a central station, said system comprising:
a central station;
at least one remote node, said at least one remote node receiving, wirelessly, data from at least one of a plurality of mobile stations; and
a wire fence connected to said at least one remote node and said central station for transferring said received data from said at least one remote node to said central station.

12. A system according to claim 11, wherein said wire fence comprises an electric fence.

13. A system according to claim 12, wherein said electric fence comprises an electric fence for containing a subject.

14. A system according to claim 11, wherein at least one of said plurality of mobile stations comprises at least one animal borne sensory device.

15. A system according to claim 11, wherein said at least one remote node comprises a radio transceiver.

16. A system according to claim 11, wherein data or command data are transmitted to at least one of said plurality of mobile stations via said at least one remote node from said central station.

17. A radio transceiver device for wirelessly communicating with at least one sensory device, said radio transceiver having power supplied by a power supply of an electric fence.

18. A radio transceiver device according to claim 17 further comprising a power tap connected to said electric fence.

19. A radio transceiver according to claim 17, wherein said electric fence comprises an electric fence for deterring a subject.

20. A radio transceiver according to claim 17, wherein said at least one sensory device comprises an animal borne sensory device.
